(19) United States
(12) Patent Application Publication
(10) Pub. No.: US 2026/0160914 A1
(43) Pub. Date: Jun. 11, 2026

(54) UNDERWATER STRUCTURE SURVEY SYSTEM

(71) Applicant: The University of Tokyo, Tokyo (JP)

(72) Inventors: Takeshi TSUJI, Tokyo (JP); Masataka UEKI, Joetsu-shi (JP); Masaharu UEKI, Joetsu-shi (JP)

(21) Appl. No.: 19/406,066

(22) Filed: Dec. 2, 2025

(30) Foreign Application Priority Data
Dec. 3, 2024 (JP) 2024-210775

(51) Int. Cl. G01V 1/38; G01V 1/18

(52) U.S. Cl. CPC G01V 1/3852; G01V 1/186; G01V 1/3808; G01V 2210/1214; G01V 2210/1297; G01V 2210/1427

(57) ABSTRACT

A seafloor structure investigation system includes an underwater speaker that is disposed in water and emits acoustic waves toward a water bottom, a vibration receiver that receives vibrations corresponding to the acoustic waves from the water bottom, and a speaker controller configured to control the underwater speaker.

### CROSS REFERENCE TO RELATED APPLICATION

This application claims benefit of priority to Japanese Patent Application 2024-210775, filed on Dec. 3, 2024, the entire content of which is incorporated herein by reference.

### BACKGROUND OF THE INVENTION

### Technical Field

The present invention relates to a underwater structure survey system.

### Description of the Related Art

As a system for investigating a geological structure, JP 2024-39369 A discloses a seismic prospecting system. The seismic prospecting system includes a seismic source device that is disposed on the ground and eccentrically rotates a rotating body to generate vibration, a signal acquisition device that acquires a vibration signal based on the vibration generated by the seismic source device, and a management device that manages the seismic source device and the signal acquisition device. The management device analyzes a geological condition using the vibration signal from the signal acquisition device.

### SUMMARY

On the other hand, as a system for investigating a geological structure (water bottom structure) in water, a method using an air gun as a seismic source device is known. In the method using an air gun, a compressor is disposed on a ship, air compressed by the compressor is instantaneously discharged into water by the air gun to generate vibration, and a vibration receiver receives a reflected wave of the vibration.

In the method using an air gun, it is necessary to dispose a device such as a compressor on a ship. Thus, a geological structure in water is investigated using a relatively large ship. Thus, it takes time and effort to operate the ship, and there is a problem that the investigation of the water bottom structure is inefficient.

The present invention has been made in view of the above problem, and it provides a underwater structure survey system capable of efficiently investigating a water bottom structure.

One aspect of the present invention provides a underwater structure survey system including an underwater speaker that is disposed in water and emits acoustic waves toward a water bottom, a vibration receiver that receives vibrations corresponding to the acoustic waves from the water bottom, and a speaker controller configured to control the underwater speaker.

According to the configuration, a device such as a compressor attached to an air gun is unnecessary when the water bottom structure is investigated using the underwater speaker. Thus, the water bottom structure can be investigated without operating a relatively large ship, and thus, the water bottom structure can be efficiently investigated.

The underwater structure survey system may further include an anchoring device for fixing the underwater speaker to a fixed point in the water. Here, the fixing to a fixed point means that the underwater speaker is prevented from moving from a predetermined place, or that the underwater speaker stays in a predetermined place and its periphery.

According to the configuration, the underwater speaker which is an acoustic source of acoustic waves is fixed at a fixed point in water. Thus, the accuracy of the investigation of the water bottom structure improves.

The anchoring device may include a weight to be sunk in the water together with the underwater speaker, and when the weight lands on the water bottom, the underwater speaker may be disposed near the water bottom. Here, disposing the underwater speaker near the water bottom means, for example, disposing the underwater speaker such that the lower end surface of the speaker falls within a range up to a predetermined distance from the water bottom (for example, a distance equal to or less than the thickness of the underwater speaker) when the lower end surface of the speaker emits acoustic waves.

According to the configuration, the underwater speaker which is an acoustic source of acoustic waves is disposed near the water bottom to be investigated. Thus, the accuracy of the investigation of the water bottom structure improves.

The anchoring device may include a weight to be sunk in the water together with the underwater speaker, and a float that gives buoyancy to the underwater speaker, and when the weight lands on the water bottom, the underwater speaker may float in the water having a predetermined interval with respect to the water bottom.

According to the configuration, by causing the underwater speaker to float in water, the underwater speaker can be prevented from sinking to the water bottom by its own weight even when the water bottom is weak. That is, the floating of the underwater speaker in water can suppress a change in depth of the underwater speaker. Thus, the accuracy of the investigation of the water bottom structure improves.

The underwater structure survey system may continuously and repeatedly emit the acoustic waves having the same waveform, and the underwater structure survey system may further include a stacker that stacks waveforms of the reflected vibrations received by the vibration receiver.

According to the configuration, the signal-to-noise ratio (S/N ratio) can be improved by stacking the waveforms of the vibration. This allows an investigation of a water bottom structure of a distant place (a place far from the underwater speaker) where only weak vibration can be received by one oscillation, for example. As a result, the range of investigation can be expanded.

The underwater structure survey system according to the present invention can efficiently investigate the water bottom structure.

### BRIEF DESCRIPTION OF DRAWINGS

FIG. 1 is a schematic view illustrating a underwater structure survey system according to an embodiment of the present invention;

FIG. 2 is a perspective view illustrating an underwater speaker and a weight according to the embodiment of the present invention;

FIG. 3 is a sectional view illustrating a configuration of the underwater speaker according to the embodiment of the present invention;

FIG. 4 is a block diagram illustrating a configuration of the underwater structure survey system according to the embodiment of the present invention;

FIG. 5 is a diagram illustrating an example of the waveform of acoustic waves emitted by the underwater speaker according to the embodiment of the present invention;

FIG. 6 is a schematic view illustrating a underwater structure survey system according to a modification of the present invention; and

FIG. 7 is a schematic view illustrating a underwater structure survey system according to another modification of the present invention.

### DETAILED DESCRIPTION

### Embodiment

Hereinafter, a seafloor structure investigation system 100 (an example of a underwater structure survey system) according to an embodiment of the present invention will be described with reference to the accompanying drawings.

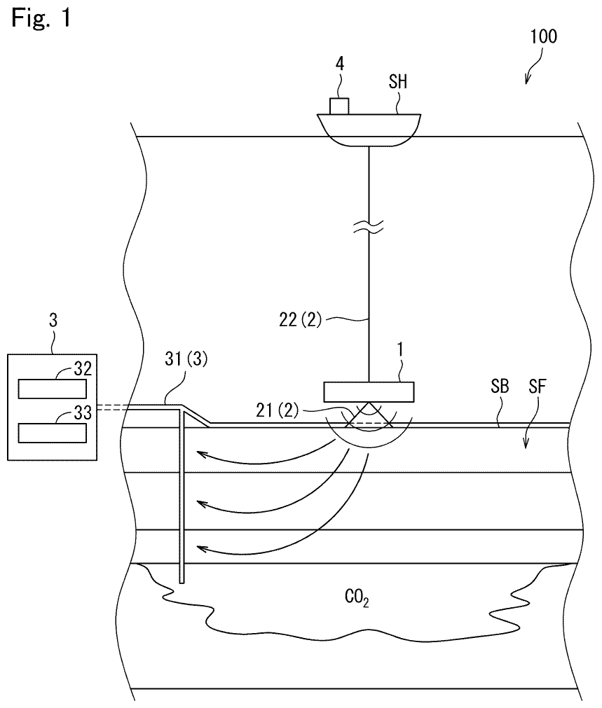

As illustrated in FIG. 1, the seafloor structure investigation system 100 is used to investigate a structure of a seafloor SF (an example of a water bottom). In the present embodiment, the seafloor structure investigation system 100 is used for continuously monitoring a CO₂ reservoir layer in which CO₂ (carbon dioxide) is stored in the seafloor SF. By continuously monitoring the CO₂ reservoir layer, for example, the presence or absence of leakage of CO₂ from the CO₂ reservoir layer can be detected. CO₂ is stored in the seafloor SF at a depth of, for example, 1 km below a seabed SB.

The seafloor structure investigation system 100 includes an underwater speaker 1, a vibration receiving device 3, and a control device 4. The seafloor structure investigation system 100 also includes an anchoring device 2 for fixing the underwater speaker 1 at a fixed point in the sea.

### Underwater Speaker

The underwater speaker 1 is disposed in the sea and emits acoustic waves toward the seafloor SF. In the present embodiment, the underwater speaker 1 is conveyed to an oscillation point by a small ship SH with a gross tonnage of less than 20 tons and is caused to sink in the sea.

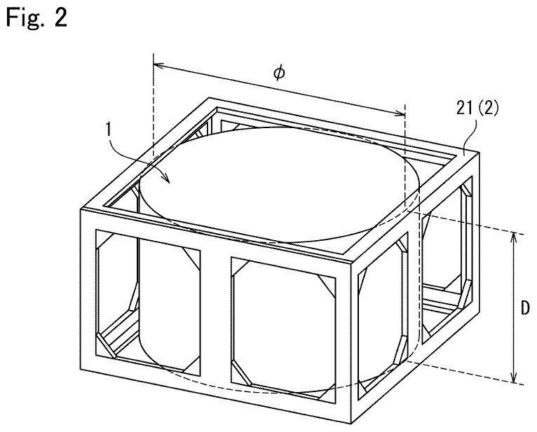

As illustrated in FIG. 2, the underwater speaker 1 is a cylindrical speaker having a diameter φ of from 0.1 to 1 m (for example, 0.4 m) and a thickness D (length in an axial direction DX1) of from 0.05 to 0.5 m (for example, 0.1 m), and is small enough to be carried by one person. The underwater speaker 1 is configured with water-resistant and pressure-resistant specifications, and can oscillate acoustic waves in seawater.

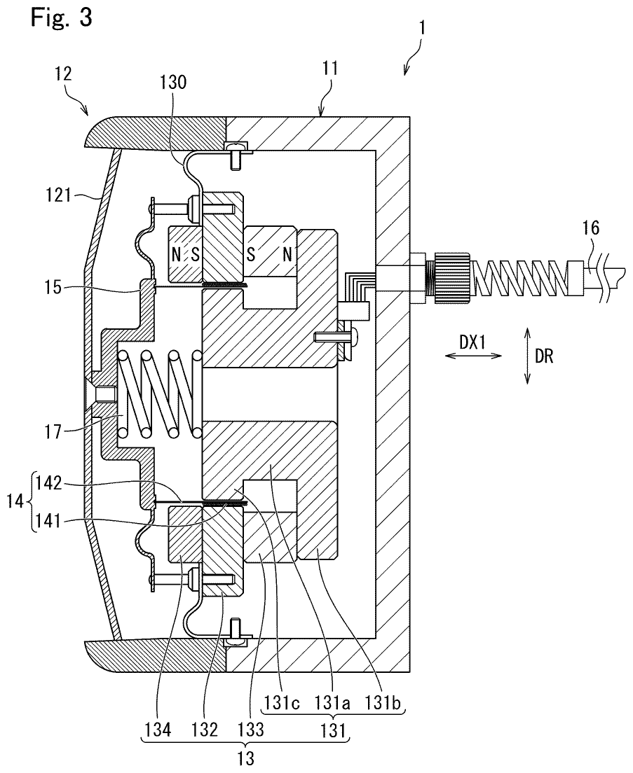

As illustrated in FIG. 3, the underwater speaker 1 includes a bottomed cylindrical exterior case 11 whose one side is open, a lid 12 that closes the opened portion of the exterior case 11 and forms a sealed space with the exterior case 11, a magnetic circuit part 13 that generates a magnetic flux in the sealed space, a voice coil 14 movable along an axial direction DX1 of the exterior case 11, a connection member 15 connected to the voice coil 14, and a compression spring 17 disposed between the connection member 15 and the magnetic circuit part 13.

The exterior case 11 and the lid 12 are made of a material that has heat resistance and is less likely to deteriorate over time, such as stainless steel.

The lid 12 includes an elastically deformable diaphragm 121 having a circular shape as viewed along the axial direction DX1. The thickness (length in the axial direction DX1) of the diaphragm 121 is set according to the acoustic pressure emitted by the underwater speaker 1. In the present embodiment, the underwater speaker 1 emits acoustic waves having an acoustic pressure of 150 dB or more and 170 dB or less and a median value of 160 dB. The size (diameter φ) of the diaphragm 121 is appropriately changed according to the depth of the seafloor SF to be investigated, the geological condition, and the like.

The magnetic circuit part 13 includes an elastic member 130, a first yoke 131 and a second yoke 132 that are magnetic bodies, and a first magnet 133 and a second magnet 134 that are permanent magnets. The magnetic circuit part 13 is attached to the exterior case 11 via the elastic member 130. The second yoke 132, the first magnet 133, and the second magnet 134 each have an annular shape centered on the axial direction DX1.

The first yoke 131 has a cylindrical part 131a having a cylindrical shape with the axial direction DX1 as an axial center. The first yoke 131 includes a first flange 131b extending outward in a radial direction DR at the end of the cylindrical part 131a far from the diaphragm 121, and a second flange 131c extending outward in the radial direction DR at the end close to the diaphragm 121.

The second yoke 132 is disposed on the outer periphery of the second flange 131c of the first yoke 131. The voice coil 14 is disposed between the second flange 131c of the first yoke 131 and the second yoke 132.

The first magnet 133 is disposed between the first flange 131b and the second yoke 132 in the axial direction DX1. The first magnet 133 is magnetized over the entire circumference, and is disposed such that the side close to the diaphragm 121 is an S pole, and the side far from the diaphragm 121 is an N pole.

The second magnet 134 is disposed so as to face the first magnet 133 in the axial direction DX1 with the second yoke 132 interposed therebetween. The second magnet 134 is magnetized over the entire circumference, and is disposed such that the side close to the diaphragm 121 is an N pole, and the side far from the diaphragm 121 is an S pole.

The voice coil 14 is connected to the diaphragm 121 via a bottomed tubular connection member 15. The voice coil 14 includes a coil part 141 and a bobbin part 142 connected to the connection member 15. The coil part 141 is formed in a spiral shape and is disposed in the magnetic flux formed by the first magnet 133 and the second magnet 134.

When an electric signal is input to the underwater speaker 1 via a signal line 16, electricity flows through the voice coil 14. This causes the Lorentz force to act on the voice coil 14, and the connection member 15 moves along the axial direction DX1 together with the voice coil 14. As a result, the diaphragm 121 vibrates, and acoustic waves are generated. The compression spring 17 is disposed between the connection member 15 and the first yoke 131, and biases the magnetic circuit part 13 toward the side away from the diaphragm 121. With the biasing of the compression spring 17 in this manner, the underwater speaker 1 can generate vibration even when receiving water pressure.

### Anchoring Device

The anchoring device 2 illustrated in FIGS. 1 and 2 has a weight 21 formed in a frame shape and surrounding the underwater speaker 1. Although not illustrated, the weight 21 is provided with a plurality of portions protruding from the weight 21 toward the underwater speaker 1, and the underwater speaker 1 is fixed to the plurality of portions with bolts.

The weight 21 is caused to sink in the sea with the underwater speaker 1 when the structure of the seafloor SF is investigated. At this time, when the weight 21 lands (comes into contact with) the seabed SB, the underwater speaker 1 is positioned (disposed) near the seafloor SF. In the present embodiment, the underwater speaker 1 is positioned near the seafloor SF such that the distance from the seafloor SF is equal to or less than the thickness D of the underwater speaker 1, preferably equal to or less than ½ of the thickness D, more preferably equal to or less than ¼ of the thickness D.

### Vibration Receiving Device

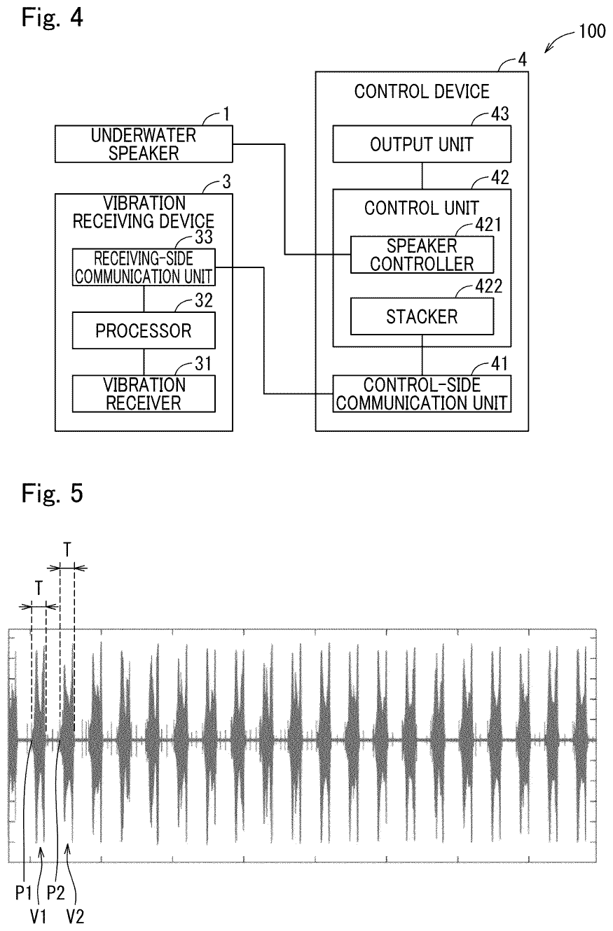

The vibration receiving device 3 receives reflected vibration (an example of vibration corresponding to acoustic vibration) reflected by the seafloor SF. As illustrated in FIG. 4, the vibration receiving device 3 includes a vibration receiver 31, a processor 32, and a receiving-side communication unit 33. In the present embodiment, the vibration receiving device 3 is a distributed acoustic sensor (DAS) using an optical fiber as the vibration receiver 31. However, the vibration receiving device 3 is not limited to DAS, and it may be an ocean bottom seismometer (OBS: Ocean Bottom Observations, OBN: Ocean Bottom Node) as described later.

The vibration receiver 31 includes a light source that emits light, an optical fiber that is installed on the seafloor SF and through which light emitted from the light source passes, and a light receiving element that receives light from the optical fiber. The light receiving element receives scattered light generated through application of vibration to the optical fiber and outputs a signal (electric signal). The optical fiber is installed along the seabed SB and is also installed along the depth direction.

The processor 32 includes a central processing unit (CPU) or a micro processing unit (MPU) that realizes a predetermined function in cooperation with software. The processor 32 outputs a signal indicating reflected vibration based on a signal output from the vibration receiver 31 (light receiving element). The processor 32 may include a storage area such as a semiconductor memory, and store the software, a signal indicating reflected vibration (data indicating reflected vibration), and the like.

The receiving-side communication unit 33 includes, for example, a communication circuit, and communicates with the control device 4 according to a communication standard such as Ethernet or Wi-Fi (registered trademark). The receiving-side communication unit 33 transmits the signal indicating the reflected vibration acquired by the processor 32 to the control device 4. In the present embodiment, the receiving-side communication unit 33 transmits the signal indicating reflected vibration to the control device 4 in real time.

### Control Device

The control device 4 includes a control-side communication unit 41, a control unit 42, and an output unit 43, and is mounted on the ship SH. The output unit 43 is, for example, a display. The control device 4 is, for example, an information processing terminal such as a personal computer, and it includes, for example, an input unit (not illustrated) as a configuration included in the information processing terminal other than the control-side communication unit 41, the control unit 42, or the output unit 43. The input unit is formed of a touch sensor, a keyboard, and the like, and receives a user's operation.

The control-side communication unit 41 includes a communication circuit, and it communicates with the vibration receiving device 3 according to a communication standard capable of communicating with the receiving-side communication unit 33. The control-side communication unit 41 receives the signal indicating the reflected vibration transmitted from the receiving-side communication unit 33 of the vibration receiving device 3. In the present embodiment, the control-side communication unit 41 and the receiving-side communication unit 33 wirelessly communicate with each other.

The control unit 42 includes a CPU or an MPU that realizes a predetermined function in cooperation with software, and functions as a speaker controller 421 and a stacker 422. The control unit 42 includes a storage area such as a semiconductor memory and stores the software, the signal (data) received from the vibration receiving device 3, data necessary for vibrating the underwater speaker 1, and the like in the storage area.

The control unit 42 is connected to the underwater speaker 1 in a wired manner (with a linear member 22 such as a rope illustrated in FIG. 1). The speaker controller 421 supplies an electric signal to the underwater speaker 1 to cause the underwater speaker 1 to oscillate. The speaker controller 421 supplies the electric signal to the underwater speaker 1 via the linear member 22 (see FIG. 1) connected to the signal line 16 of the underwater speaker 1.

The speaker controller 421 can change the frequency of the acoustic waves to be emitted from the underwater speaker 1. In the present embodiment, the speaker controller 421 causes the underwater speaker 1 to oscillate and generate acoustic waves at a frequency selected from 10 Hz to 10,000 Hz. By setting the frequency in this manner, damping of vibration is suppressed.

The speaker controller 421 causes the underwater speaker 1 to oscillate a chirp signal (sine wave) whose frequency changes with time as acoustic waves. In the present embodiment, the speaker controller 421 causes the underwater speaker 1 to oscillate a down-chirp signal whose frequency decreases with time.

The speaker controller 421 continuously repeats the same waveform for each chirp period T and causes the underwater speaker 1 to oscillate (see FIG. 5). The same waveform is substantially the same waveform, and it refers to a waveform having the same or similar frequency change and the same or similar amplitude in unit time. The number of oscillations is determined according to the depth and the geological condition of the seafloor SF to be investigated.

The stacker 422 stacks the continuously and repeatedly oscillated reflection vibrations based on the signal indicating the reflection vibrations received from the vibration receiving device 3. Specifically, the stacker 422 combines a plurality of waveforms for each chirp period T with the oscillation start times on the time axis aligned.

For example, the stacker 422 stacks a plurality of waveforms so as to match the oscillation start time P1 of a first waveform V1 and the oscillation start time P2 of a second waveform V2 indicating the reflection vibration illustrated in FIG. 5 and to stack the first waveform V1 and the second waveform V2. The stacker 422 outputs a result of stacking the plurality of waveforms via the output unit 43. The control unit 42 cross-correlates a signal (stacked waveforms) from the vibration receiving device 3 with a starting waveform from the speaker controller 421. As a result, it is possible to obtain a record similar to that when an impulsive waveform is transmitted by the underwater speaker 1. The control unit 42 may analyze the structure of the seafloor SF based on the result of the stacking, and may output the result of analyzing the structure of the seafloor SF via the output unit 43.

### Method for Performing Seafloor Investigation

The investigation of the structure of the seafloor SF using the seafloor structure investigation system 100 is performed as follows. First, the ship SH on which the underwater speaker 1 is mounted is directed to an oscillation point (CO₂ reservoir layer) determined in advance, and the underwater speaker 1 on which the anchoring device 2 is mounted is disposed in water by controlling the position thereof.

After the underwater speaker 1 is disposed, the underwater speaker 1 is caused to execute oscillation work of repeatedly oscillating acoustic waves of the same waveform. The oscillation work is started when the operator inputs an operation instructing execution of the oscillation work to the control device 4. As described above, the number of oscillations is determined according to the depth, geological condition, and the like of the investigation target.

After completion of the oscillation work, the underwater speaker 1 is collected in the ship SH, and the ship SH moves the underwater speaker 1 to the next oscillation point. The underwater speaker 1 is caused to perform the oscillation work at the next oscillation point in the same manner. In this manner, the underwater speaker 1 is caused to repeatedly execute the oscillation work in the region covering the CO₂ reservoir layer. The underwater speaker 1 repeatedly performs the oscillation work in the region covering the CO₂ reservoir layer, and the reflected wave (stacked reflected wave) obtained through the oscillation work is analyzed, whereby the CO₂ reservoir layer can be continuously monitored.

### Effects of Embodiment

An air gun used in marine research requires a large-scale device such as a compressor. On the other hand, when the structure of the seafloor SF is investigated using the underwater speaker 1 according to the embodiment described above, a device such as a compressor attached to an air gun is unnecessary. Thus, the structure of the seafloor SF can be investigated without operating a relatively large ship, and thus, the water bottom structure can be efficiently investigated.

In addition, the air gun requires a compressor as described above, and because a hydrophone array having a length of several kilometers is towed, a large ship is required for marine research, which is costly and unsuitable for continuous (high-frequency) investigation of a seafloor structure. On the other hand, because the underwater speaker 1 is small as described above, a large ship is unnecessary, and the cost is also suppressed. Thus, the underwater speaker 1 can also be applied to continuous (high-frequency) investigation of a seafloor structure.

In addition, because the air gun instantaneously emits acoustic waves with high energy (for example, acoustic pressure exceeding 200 dB), there is a concern about an influence (environmental load) on the environment of fishery, marine organisms, and the like. On the other hand, because the underwater speaker 1 according to the present embodiment emits acoustic waves having an acoustic pressure of about 160 dB, it is possible to suppress the influence on the environment of fishery, marine organisms, and the like, and the environmental load is reduced. Further, the underwater speaker 1 according to the present embodiment is small in size, and has lower power consumption than the case of using an air gun, thus, it can also contribute to energy saving.

In addition, because the diaphragm 121 (vibration surface) vibrates, the underwater speaker 1 can efficiently generate vibrations in the sea water, and the vibrations (acoustic waves) from the underwater speaker 1 are more reliably transmitted to the seafloor SF.

According to the embodiment described above, the underwater speaker 1 is fixed to the seafloor SF (fixed point) by the anchoring device 2. That is, because the underwater speaker 1 which is the oscillation source of the acoustic waves is fixed at a fixed point in water, the accuracy of the investigation of the structure of the seafloor SF improves. In particular, in the embodiment described above, because the position of the underwater speaker 1 which is the oscillation source of the acoustic waves is disposed near the seafloor SF to be investigated, the accuracy of the investigation of the structure of the seafloor SF improves.

According to the embodiment described above, the stacker 422 of the control device 4 stacks the waveforms of the vibration received by the vibration receiver 31. That is, the vibration received from the vibration receiving device 3 can be amplified. This can improve the signal-to-noise ratio (S/N ratio). For example, it is possible to investigate the structure of the seafloor SF in a distant place (a place far from the underwater speaker 1) where only weak vibration can be received by one oscillation. As a result, the range of investigation can be expanded.

In addition, as described in the embodiment described above, because the seafloor structure investigation system 100 uses an optical fiber as the vibration receiver 31, it is possible to acquire reflected vibrations at a plurality of points in real time and to improve spatial resolution. In addition, because the optical fiber used as the vibration receiver 31 is an existing infrastructure, the disposition work of the vibration receiving device 3 and the work of collecting data indicating the acquired reflected vibration are facilitated as compared with the case of using an ocean bottom seismometer, for example, and the cost can be suppressed.

### Modifications

In the embodiment described above, the control device 4 is mounted on the ship SH. However, the control device 4 may be disposed on land. When such a change is made, the control device 4 may wirelessly control the underwater speaker 1.

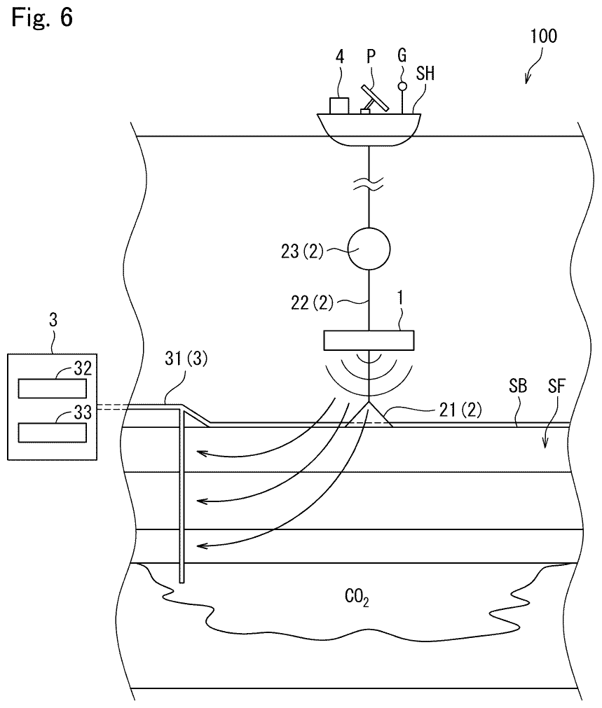

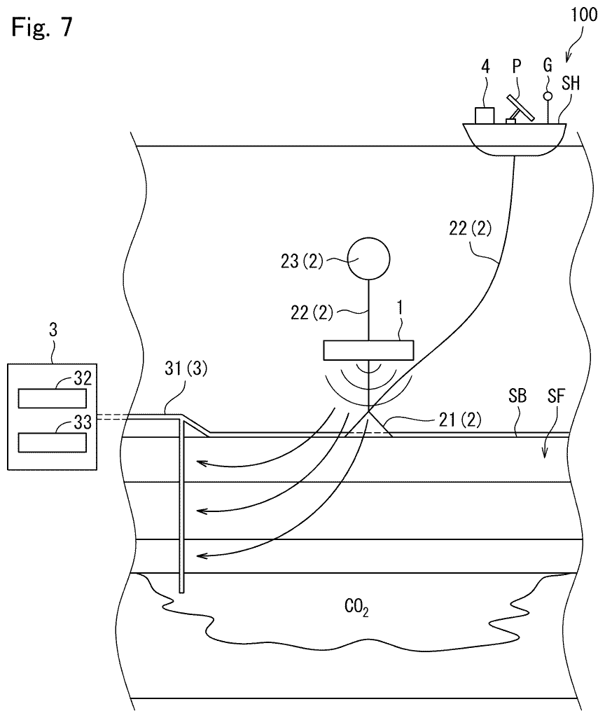

In the embodiment described above, the vibration receiving device 3 is fixed at a fixed point by the weight 21 disposed on the seabed SB, but the method of fixing the underwater speaker 1 is appropriately changed according to the environment of the sea floor (for example, the degree of softness of the seafloor ground). For example, as illustrated in FIG. 6, the anchoring device 2 may further have a float 23 that gives buoyancy to the underwater speaker 1, and in this case, the underwater speaker 1 is spaced with respect to the seabed SB and floats in the sea when the weight 21 lands (comes into contact with) the seabed SB. The float 23 may be indirectly connected to the underwater speaker 1 (for example, via the linear member 22), or may be directly connected to the underwater speaker 1. Further, when the underwater speaker 1 is caused to float in water, the weight 21 and the ship SH may be directly connected by the linear member 22 as illustrated in FIG. 7. By causing the underwater speaker 1 to float in water, it is possible to avoid the underwater speaker 1 from sinking on the seafloor SF by its own weight even when the seabed SB is weak. That is, the depth change of the underwater speaker 1 can be suppressed. Therefore, the accuracy of investigating the structure of the seafloor SF improves.

The ship SH described in the embodiment described above may include a solar panel P that generates power with sunlight, and the ship SH may supply the power generated by the solar panel P to the underwater speaker 1 via the linear member 22. As described above, because the power consumption of the underwater speaker 1 is small, a long-term monitoring with the power generated by the solar panel P is possible. The ship SH may further include a battery system B (secondary battery) that stores the electric power generated by the solar panel P, and may supply the electric power (signal) stored in the battery system B to the underwater speaker 1. This allows the underwater speaker 1 to continuously emit acoustic waves for a long time.

The ship SH may further include a GPS time server G (GPS antenna) for acquiring time, and the speaker controller 421 may determine a trigger for emitting acoustic waves from the underwater speaker 1 with reference to the time of the GPS time server G.

The ship SH described in the embodiment described above may be a manned operation ship or an unmanned exploration ship in unmanned operation. When the ship SH is an unmanned exploration ship, the underwater speaker 1 can continuously emit acoustic waves at the same point for a long time.

In the embodiment described above, a case where the vibration receiving device 3 (processor 32) is an optical fiber distribution type vibration sensor has been described, but the vibration receiving device 3 may be a seismometer (ocean bottom seismometer) other than an optical fiber distribution type vibration sensor. When the vibration receiving device 3 is configured by the seismometer, the seafloor structure investigation system 100 may include a plurality of vibration receiving devices 3, and each of the plurality of vibration receiving devices 3 may receive reflected vibrations at a plurality of points. This can construct a three-dimensional geological model. Reflected vibrations at a plurality of points may be received by moving one vibration receiving device 3. The vibration receiving device 3 may be an ocean bottom cable (OBC) seismometer.

In the present embodiment, a case where one underwater speaker 1 sequentially moves through a plurality of points and emits acoustic waves at each point has been described, but a plurality of underwater speakers 1 may be disposed at a plurality of points to emit acoustic waves. The underwater speaker 1 may emit acoustic waves only at one point instead of a plurality of points.

In the embodiment described above, a case where a down-chirp signal is emitted as the acoustic waves oscillated from the underwater speaker 1 has been described, but the underwater speaker 1 may emit an up-chirp signal whose frequency increases with the time. In addition, the underwater speaker 1 may emit acoustic waves excluding frequencies that marine organisms living in the water (fish, mammalia, etc.) dislike. Further, the underwater speaker 1 may emit, for example, a pseudo random wave or the like other than chirp signals as the acoustic waves.

In the embodiment described above, the stacker 422 stacks the signals indicating the reflected vibrations received from the vibration receiving device 3, that is, the reflected waves, but the stacker 422 may stack refractive waves other than the reflected waves, surface waves, and the like.

In the embodiment described above, the waveforms of the reflection vibration are stacked. However, for example, in the investigation of a point where the distance from the underwater speaker 1 is short, the waveforms of the reflection vibration do not have to be stacked.

In the embodiment described above, the stacker 422 outputs the result of stacking a plurality of waveforms via the output unit 43 such as a display, but the control unit 42 may output the result of stacking to an external device via the control-side communication unit 41. The control unit 42 may analyze the structure of the seafloor SF based on the result of stacking and output a result of analyzing the structure of the seafloor SF.

In the embodiment described above, the speaker controller 421 and the stacker 422 are realized by the control device 4, but the speaker controller 421 and the stacker 422 may be realized by different devices. The processor 32 of the vibration receiving device 3, the speaker controller 421, and the stacker 422 may be realized by one control device 4, or may be realized by different devices.

In the embodiment described above, the weight 21 has been described as an example of the anchoring device 2, but the anchoring device 2 may be a submersible on which the underwater speaker 1 is mounted.

In the embodiment described above, the underwater speaker 1 is disposed in sea water, but the underwater speaker 1 may be disposed in water other than sea water, such as a lake or a river, and the underwater speaker 1 may be disposed at the bottom of a lake or the bottom of a river.

In the embodiment described above, a case where the seafloor structure investigation system 100 is used to monitor the CO₂ reservoir layer has been described, but the seafloor structure investigation system 100 can also be used to investigate a water bottom structure other than the CO₂ reservoir layer.

What is claimed is

1. A underwater structure survey system comprising:
an underwater speaker that is disposed in water and emits acoustic waves toward a water bottom;
a vibration receiver configured to receive vibrations corresponding to the acoustic waves from the water bottom; and
a speaker controller configured to control the underwater speaker.

2. The underwater structure survey system according to claim 1, further comprising an anchoring device for fixing the underwater speaker to a fixed point in the water.

3. The underwater structure survey system according to claim 2, wherein
the anchoring device includes a weight to be sunk in the water together with the underwater speaker, and
when the weight lands on the water bottom, the underwater speaker is disposed near the water bottom.

4. The underwater structure survey system according to claim 2, wherein
the anchoring device includes a weight to be sunk in the water together with the underwater speaker, and a float that gives buoyancy to the underwater speaker, and
when the weight lands on the water bottom, the underwater speaker floats in the water having a predetermined interval with respect to the water bottom.

5. The underwater structure survey system according to claim 1, wherein
the underwater speaker continuously and repeatedly emits the acoustic waves having the same waveform, and
the underwater structure survey system further comprises a stacker that stacks waveforms of the reflected vibrations received by the vibration receiver.

6. The underwater structure survey system according to claim 2, wherein
the underwater speaker continuously and repeatedly emits the acoustic waves having the same waveform, and
the underwater structure survey system further comprises a stacker that stacks waveforms of the reflected vibrations received by the vibration receiver.
